(19) United States
(12) Patent Application Publication
(10) Pub. No.: US 2005/0194908 A1
(43) Pub. Date: Sep. 8, 2005

(54) Ceramic metal halide lamp with optimal shape

(75) Inventors: James T. Dakin, Shaker Heights, OH (US); Matthew Bugenske, Cleveland Heights, OH (US); Gary W. Utterback, University Heights, OH (US)

Correspondence Address: Timothy E. Nauman;FAY, SHARPE, FAGAN, MINNICH & McKEE, LLP, Seventh Floor, 1100 Superior Avenue, Cleveland, OH, 44114, US

(73) Assignee: General Electric Company, Schenectady, NY (US)

(21) Appl. No.: 10/792,996

(22) Filed: Mar. 4, 2004

(51) Int. Cl. H01K 1/62

(52) U.S. Cl. 315/56; 315/32

(57) ABSTRACT

A metal halide lamp (10) has a ceramic arctube (12) with an inside length L, an inside diameter D, and an aspect ratio L/D of between about 1.5 and about 2.0 containing a suitable fill. The lamp may have a power rating of 200 W or more and can be used with an existing ballast.

### BACKGROUND OF THE INVENTION

The present invention relates to an electric lamp having a ceramic arctube enclosing a discharge space having a length L, a diameter D, and an aspect ratio L/D which minimizes wall corrosion while providing extended life and improved performance.

Discharge lamps produce light by ionizing a vapor filler material such as a mixture of rare gases, metal halides and mercury with an electric arc passing between two electrodes. The electrodes and the filler material are sealed within a translucent or transparent discharge chamber which maintains the pressure of the energized filler material and allows the emitted light to pass through it. The filler material, also known as a “dose”, emits a desired spectral energy distribution in response to being excited by the electric arc. For example, halides provide spectral energy distributions that offer a broad choice of light properties, e.g. color temperatures, color renderings, and luminous efficacies.

Conventionally, the discharge chamber in a discharge lamp was formed from a vitreous material such as fused quartz, which was shaped into desired chamber geometries after being heated to a softened state. Fused quartz, however, has certain disadvantages which arise from its reactive properties at high operating temperatures. For example, in a quartz lamp, at temperatures greater than about 950-1000° C., the halide filling reacts with the glass to produce silicates and silicon halide, which results in depletion of the filler constituents. Elevated temperatures also cause sodium to permeate through the quartz wall, which causes depletion of the filler. Both depletions cause color shift over time, which reduces the useful lifetime of the lamp.

Ceramic discharge chambers were developed to operate at higher temperatures for improved color temperatures, color renderings, and luminous efficacies, while significantly reducing reactions with the filler material.

High wattage (over 150 W) metal halide lamps, however, are generally available only with quartz arctubes, which are larger than ceramic arctubes. Recently, attempts have been made to develop ceramic arctubes which are capable of operating at high wattage. U.S. Pat. No. 6,583,563 discloses a ceramic metal halide lamp. For a 150 watt lamp, the body portion has a length of an inner diameter of about 9.5 mm and outer diameter of about 11.5 mm. U.S. Pat. No. 6,555,962 discloses a metal halide lamp with a power rating of 200 W or more to be used with an existing ballast for a high pressure sodium (HPS) lamp of like power rating. The inside diameter D and inside length L are selected so as to provide an aspect ratio L/D of between 3 and 5.

Despite improvements, commercially available vessels for CMH lamps tend to have poor performance in terms of lumen output, color separation, and horizontal cracking when operated at high wattage.

The present invention provides a new and improved vessel for a metal halide lamp operating at high power.

### BRIEF DESCRIPTION OF THE INVENTION

In an exemplary embodiment of the present invention, a lighting assembly is provided. The assembly includes a ballast and a lamp electrically connected therewith. The ballast is selected such that the lamp operates at a power of greater than 200 W. The lamp includes a discharge vessel containing a fill of an ionizable material. The discharge vessel includes a body portion which defines an interior space. The body portion has an internal length, parallel to a central axis of the discharge vessel, and an internal diameter, perpendicular to the internal length. The ratio of the internal length to the internal diameter is in the range of 1.5 to 2.0. At least one leg portion extends from the body portion. At least one electrode is positioned within the discharge vessel so as to energize the fill when an electric current is applied thereto

In another exemplary embodiment of the present invention, a ceramic metal halide lamp capable of operating at a power of at least 200 W is provided. The lamp comprises a body portion formed of a ceramic material which defines an interior space. The body portion has an internal length, parallel to a central axis of the discharge vessel and an internal diameter, perpendicular to the internal length. A ratio of the internal length to the internal diameter is in the range of 1.5 to 2.0. Spaced electrodes extend into the body portion. An ionizable fill is disposed in the body portion.

In another exemplary embodiment of the present invention, a method of forming a lighting assembly capable of operating at a power of at least 200 W is provided. The method includes providing a substantially cylindrical discharge vessel comprising a body portion and first and second leg portions extending from the body portion, the body portion having an aspect ratio of internal length to internal diameter of from 1.5 to 2.0 and a wall thickness of at least 1 mm. An ionizable fill is disposed in the body portion. Electrodes are positioned within the discharge vessel which energize the fill when an electric current is applied to the electrodes.

One advantage of at least one embodiment of the present invention is the provision of a ceramic arctube with improved performance and life.

Another advantage of at least one embodiment of the present invention is that the relationship between structural elements such as dimensions of the arctube are optimized.

Still further advantages of the present invention will become apparent to those of ordinary skill in the art upon reading and understanding the following detailed description of the preferred embodiments.

As used herein, “Arctube Wall Loading” (WL) is the arctube power (watts) divided by the arctube surface area (square mm). For purposes of calculating WL, the surface area is the total external surface area including end bowls but excluding legs, and the arctube power is the total arctube power including electrode power.

The “Ceramic Wall Thickness” (ttb) is defined as the thickness (mm) of the wall material in the central portion of the arctube body.

The “Aspect Ratio” (L/D) is defined as the internal arctube length divided by the internal arctube diameter.

The “Halide Weight” (HW) is defined as the weight (mg) of the halides in the arctube.

### BRIEF DESCRIPTION OF THE DRAWINGS

FIG. 1 is a perspective view of a lamp according to the invention;

FIG. 2 is a diagrammatic axial section view of a discharge vessel for the lamp of FIG. 1 according to a first embodiment of the invention;

FIG. 3 is a diagrammatic axial section view of a discharge vessel for the lamp of FIG. 1 according to a second embodiment of the invention;

FIG. 4 is an exploded view of the discharge vessel of FIG. 2;

FIG. 5 is a plot of power/area (W/mm²) versus the ratio of internal length/internal diameter for lamps operating on a pulse arc ballast; and

FIG. 6 is a plot of efficiency (lumens/Watt) (left ordinal axis) and operating voltage (right ordinal axis) versus the ratio of internal length/internal diameter for lamps operating on a pulse arc ballast at a color rendition index (Ra) of at least 91.

### DETAILED DESCRIPTION OF THE INVENTION

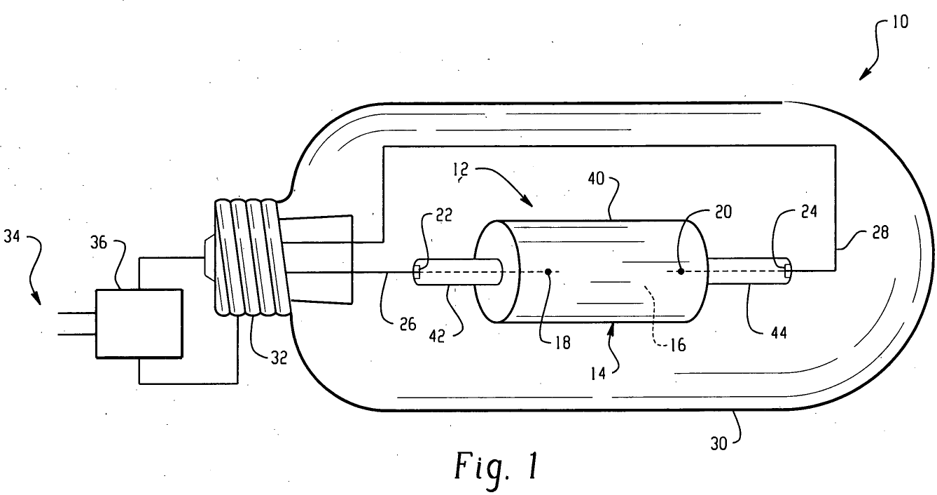

With reference to FIG. 1, lighting assembly includes a metal halide discharge lamp 10 suited to use at high wattage (>150 W). The lamp includes a discharge vessel or arctube 12 having a wall 14 formed of a ceramic or other suitable material, which encloses a discharge space 16. The discharge space contains an ionizable fill material. Electrodes 18, 20 extend through opposed ends 22, 24 of the arctube and receive current from conductors 26, 28 which supply a potential difference across the arctube and also support the arctube 12. The arctube 12 is surrounded by an outer bulb 30, which is provided with a lamp cap 32 at one end through which the lamp is connected with a source of power 34, such as mains voltage. The lighting assembly also includes a ballast 36, which acts as a starter when the lamp is switched on. The ballast is located in a circuit containing the lamp and the power source. The space between the arctube and outer bulb may be evacuated. Optionally a shroud (not shown) formed from quartz or other suitable material, surrounds or partially surrounds the arctube to contain possible arctube fragments in the event of an arctube rupture.

The ballast 36 can be of any suitable type designed to operate at >150 W. Two types which are particularly suited to operating at 200 W and above are High Pressure Sodium (HPS) and Pulse Arc (PA) ballasts. HPS ballasts are widely used for high pressure sodium lamps and can be used with lamps that are capable of operating at a nominal operating voltage Vop of 100±20V initially. The lamps suited to use with these ballasts also have a nominal arctube power factor, defined as operating power, divided by current times voltage, of about 0.87.

PulseArc or “PA” ballasts are used primarily in North America for metal halide lamps. These ballasts are different than other North American metal halide ballasts in that they include an ignitor (pulsing circuit) to initiate lamp starting. (HPS ballasts also have ignitors, but generally with lower pulse heights). The PA ballasts are suited to operation with lamps which operate at a nominal Vop=135±15V. The lamp should generally also have a nominal arctube power factor of about 0.91.

On both ballast types it is sometimes desirable to select the properties of an arctube such that it operates in the upper part of the nominal voltage range. This can improve performance. However, a too-high voltage can lead to dropout later in lamp life. A too-low voltage leads to reduced lamp performance (lumens, color).

In operation, the electrodes 18, 20, produce an arc which ionizes the fill material to produce a plasma in the discharge space. The emission characteristics of the light produced are dependent, primarily, upon the constituents of the fill material, the voltage across the electrodes, the temperature distribution of the chamber, the pressure in the chamber, and the geometry of the chamber.

For a ceramic metal halide lamp, the filler material typically comprises a mixture of Hg, a rare gas such as Ar or Xe, and a metal halide such as NaI, TlI, DyI₃, HoI₃, TmI₃, CeI₃, CaI₂, and CsI, and combinations thereof. CaI₂ acts as a color adjuster. Xenon has advantages over argon as an ignition gas because the atoms are larger and inhibit evaporation of the tungsten electrodes, so that the lamp lasts longer. In one exemplary embodiment, the fill gas includes Ar or Xe, Hg, and iodides of Na, Tl, Dy, Ho, Tm, Ce, Cs, and Ca. In one specific embodiment, for achieving a color rendering index (Ra) of>90, Efficiency of>90 lumen/W, and a color correction temperature (CCT) of ˜4000K on a pulse arc ballast, such as a North American Pulse Arc ballast, the iodides may be present in the fill, measured as a percentage by weight of the iodides at 18-25% NaI, 1.5-3% TlI, 10-15% Dy I₃, 5-8% Ho I₃, 5-8% Tm I₃, 0-1% Ce I₁3, 30-55% Ca I₂, and 1-3% CsI. In one embodiment, the fill comprises about 21% NaI, 2% TlI, 13% DyI₃, 7% HoI₃, 7% TmI₃, 1% CeI₃, 48% CaI₂ and 3% CsI. In another embodiment, suited for achieving Ra>80, Efficiency>90 lumen/W and a CCT Of ˜3000K on a HPS ballast, the fill comprises, by weight, 30-40% NaI, 2-8% TlI, 2-10% DyI₃, 1-5% HoI₃, 1-5% TmI₃, 0-1% CeI₃, 30-55% CaI₂, and 2-10% CsI. In one specific embodiment, suited for use on an HPS ballast, the fill comprises about 35% NaI, 5% TlI, 6% DyI₃, 3% HoI₃, 3% TmI₃, 42% CaI₂, and 6% CsI. Variations on this dose composition are also applicable. For a high pressure sodium lamp, the filler material typically comprises Na, a rare gas, and Hg. Other examples of filler materials are well known in the art. See, for example, Alexander Dobrusskin, Review of Metal Halide Lamps, 4th Annual International Symposium on Science and Technology of Light Sources (1986). The halide composition can be adjusted to optimize luminous, color and electrical properties of the arctube.

The mercury weight is adjusted to provide the desired arctube operating voltage (Vop) for drawing power from the selected ballast

The metal halide arctubes are back filled with a rare gas, generally Ar, to facilitate starting. In one embodiment, suited to CMH lamps, the lamp is backfilled with Ar with a small addition of Kr85. The radioactive Kr85 provides ionization which helps starting. The cold fill pressure can be about 100-200 Torr. In one embodiment a cold fill pressure of about 130 Torr is employed. A too high pressure will compromise starting. A too low pressure will lead to increased lumen depreciation over life.

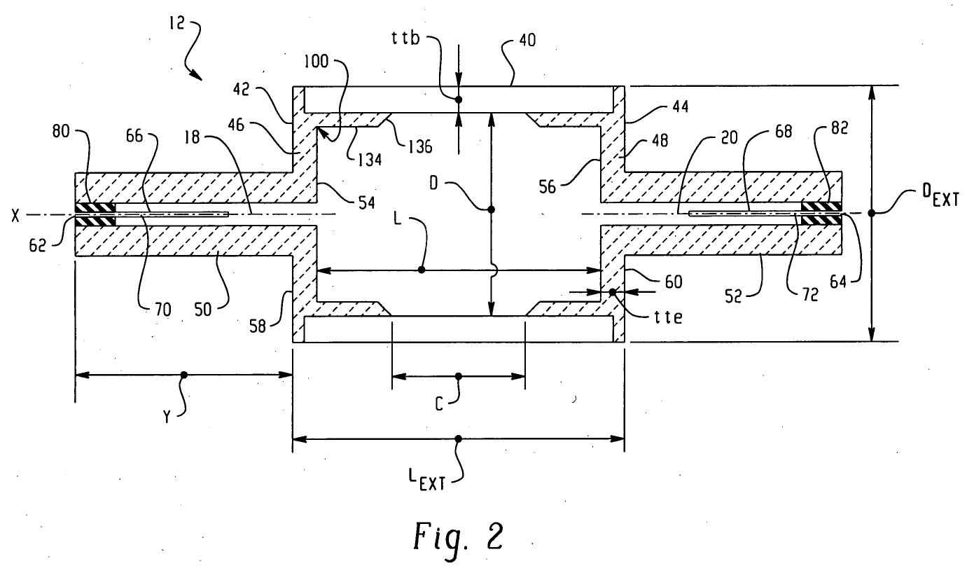

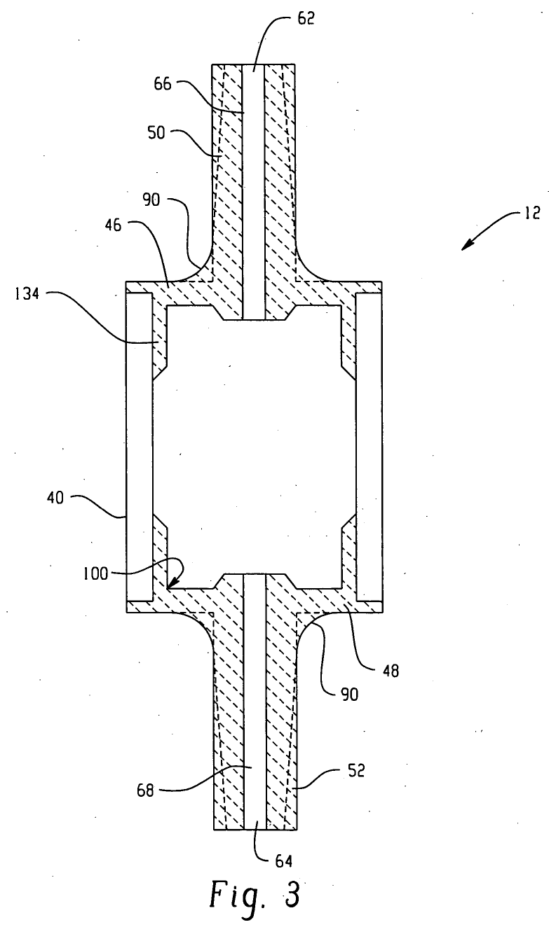

With reference also to FIGS. 2 and 3, the illustrated arctube 12 is of a three part construction. The arctube of FIG. 3 is the same as the arctube of FIG. 2, except as otherwise noted. Specifically, the arctube 12 includes a body portion 40 extending between end portions 42, 44. The body portion is preferably cylindrical or substantially cylindrical about a central axis x. By “substantially cylindrical” it is meant that the internal diameter D of the body portion does not vary by more than 10% within a central region C of the body portion which accounts for at least 40% of the interior length L of the body portion. Thus, a slightly elliptical body can be achieved without losing all of the advantages of the present invention. In one embodiment, the variation is less than 5% and in another embodiment, the variation is within the tolerances of the lamp forming process for a nominally cylindrical body. Where the diameter varies, D is measured at its widest point. The end portions, in the illustrated embodiment, are each integrally formed and comprise a generally disk-shaped wall portion 46, 48 and an axially extending hollow leg portion 50, 52, through which the respective electrodes are fitted. The leg portions may be cylindrical, as shown, or taper such that the external diameter decreases away from the body portion 40, as illustrated by the hatched lines in FIG. 3.

The wall portions 46, 48 define interior wall surfaces 54, 56 and exterior end wall surfaces 58, 60 of the discharge space; the maximum distance between the interior surfaces 54, 56, as measured along a line parallel to the axis x of the arctube being defined as L and the distance between exterior wall surfaces 58, 60 being defined as L_{EXT}. The cylindrical wall 40 has an internal diameter D (the maximum diameter, as measured in the central region defined by C) and an exterior diameter D_{EXT}.

For quartz metal halide (QMH) lamps, it has previously been understood that the aspect ratio should increase as the lamp power (in Watts) increases. In contrast to the prior art, it has unexpectedly been found that optimal aspect ratio is largely independent of the power, particularly for ceramic metal halide (CMH) arcttubes operating at about 250 W and above. If the ratio L/D is too large, then there is reduced mixing of the halide vapor with the dominant mercury vapor. If L/D is too small, then end effects associated with light blockage and reduced halide cold spot temperature can compromise lamp performance. For the arctube power range 250-400 W the ratio L/D can be in the range of 1.5 to about 2.0. in one embodiment, L/D is from 1.6 to 1.8.

The end portions 42, 44 are fastened in a gas tight manner to the cylindrical wall 40 by means of a sintered joint. The end wall portions each have an opening 62, 64 defined at an interior end of an axial bore 66, 68 through the respective leg portion 50, 52. The bores 66, 68 receive leadwires 70, 72 through seals 80, 82. The electrodes 18, 20, which are electrically connected to the leadwires, and hence to the conductors, typically comprise tungsten and are about 8-10 mm in length. The leadwires 70, 72 typically comprise niobium and molybdenum which have thermal expansion coefficients close to that of alumina to reduce thermally induced stresses on the alumina leg portions and may have halide resistant sleeves formed, for example of Mo—Al₂O₃.

The halide weight (HW) in mg can be in the range of about 40 to about 60 mg. If HW is too small, then the halides tend to be confined to the ceramic legs, which are intentionally cooler than the arctube body, and there tends to be inadequate halide vapor pressure to provide the desired arctube performance. If HW is too large, then halide tends to condense on the arctube walls where it blocks light and may lead to life limiting corrosion of the ceramic material. Under such conditions, polycrystalline alumina (PCA), in particular, tends to dissolve into the condensed liquid and is later deposited on cooler areas of the lamp. A high HW also tends to increase manufacturing cost due to the cost of the halides. In the present lamp, the end walls are hotter so the amount of halide on the walls is reduced and thus corrosion is minimized or eliminated entirely.

The ceramic wall thickness (ttb), which is equivalent to (Dₑₓₜ−D)/2, as measured in the cylindrical portion 40 is preferably at least 1 mm for arctubes operating in the range of 250-400 W. In one embodiment, the thickness is less than 1.8 mm for arctubes operating in this range. If ttb is too low, then there tends to be inadequate heat spreading in the wall through thermal conduction. This can lead to a hot local hot spot above the convective plume of the arc, which in turn causes cracking as well as a reduced limit on WL. A thicker wall spreads the heat, reducing cracking and enabling higher WL. In general, the optimum ttb increases with the size of the arctube; higher wattages benefiting from larger arctubes with thicker walls. In one embodiment, where the arctube power is in the range of 250-400 W, 1.1 mm<ttb<1.5 mm. For such an arctube, the wall loading WL may meet the expression 0.10<WL<0.20 W/mm². If WL is too high then the arctube material may tend to become too hot, leading to softening in the case of quartz, or evaporation in the case of ceramic. If WL is too low then the halide temperature tends to be too low leading to reduced halide vapor pressure and reduced performance. In one specific embodiment, 1.3<ttb<1.5. The thickness tte of the end walls 46, 48 is preferably the same as that of the body 40, i.e., in one embodiment 1.1 mm<tte<1.5 mm.

The arc gap (AG) is the distance between tips of the electrodes 18, 20. The arc gap is related to the internal arctube length L by the relationship AG+2tts=L, where tts is the distance from the electrode tip to the respective surface 54, 56 defining the internal end of the arctube body. Optimization of tts leads to an end structure hot enough to provide the desired halide pressure, but not too hot to initiate corrosion of the ceramic material. In one embodiment, tts is about 2.9-3.3 mm. In another embodiment, tts ˜3.1 mm.

The arctube legs 50, 52 provide a thermal transition between the higher ceramic body-end temperatures desirable for arctube performance and the lower temperatures desirable for maintaining the seals 80, 82 at the ends of the legs. The minimum internal diameter of the legs is dependent on the electrode-conductor diameter, which in turn is dependent on the arc current to be supported during starting and continuous operation. In an exemplary embodiment, where the power is in the range of 250-400 W, an external conductor diameter of about 1.52 mm can be employed. A ceramic leg 50, 52 whose internal and external diameters are about 1.6 and 4.0 mm, respectively is therefore suitable for such a conductor 70, 72. With these selected diameters, an external ceramic leg length Y of greater than 15 mm is generally sufficient to avoid seal cracking. In one embodiment, the legs 50, 52 each have a leg length of about 20 mm.

The cross sectional shape of the end wall portions 46, 48 which join the arctube body 40 to its legs 50, 52 can be one in which a sharp corner is formed at the intersection between the end wall portion 46, 48 and the leg, as illustrated in FIG. 2. However, as illustrated in FIG. 3 a fillet 90 in the region of the intersection is alternatively provided. A smooth fillet transition between the exterior end and the leg and the end wall portion assists in reducing stress concentrations at the intersection.

The end wall portions are provided with a thickness large enough to spread heat but small enough to prevent or minimize light blockage. Discrete interior corners 100 provide a preferred location for halide condensation. The structure of the endwall portion 46, 48 enables a more favorable optimization, significantly one with a lower L/D. The following features, alone or in combination, have been found to assist in optimizing performance: 1) a smooth fillet transition between the exterior end and the leg so as to reduce stress concentrations, 2) an end thickness large enough to spread heat but small enough to prevent light blockage, and 3) discrete corners to provide a preferred location for halide condensation.

The seals 80, 82 typically comprise a dysprosia-alumina-silica glass and can be formed by placing a glass frit in the shape of a ring around one of the leadwires 70, 72, aligning the arctube 12 vertically, and melting the frit. The melted glass then flows down into the leg 50, 52, forming a seal 80, 82 between the conductor and the leg. The arctube is then turned upside down to seal the other leg after being filled with the filler material.

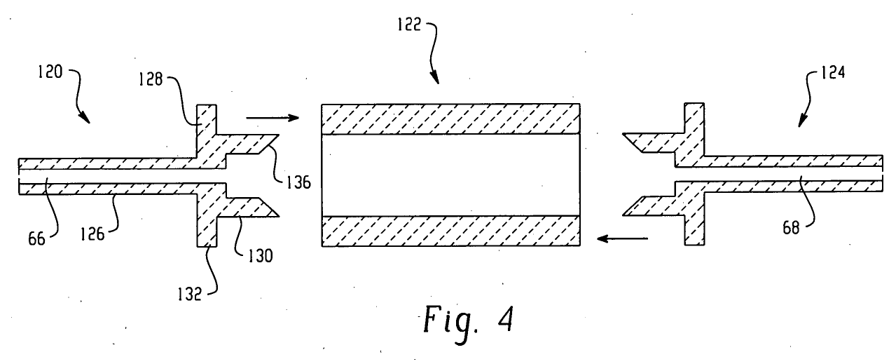

The exemplary body and plug members 120, 122, 124 shown in FIG. 4 can greatly facilitate manufacturing of the discharge chamber, since the plug members 120, 124 include a leg member 126 and an end wall member 128, and an axially directed flange 130 formed as a single piece. A radially extending flange 132 is configured for seating against the opposed ends of the body 122. The components shown in FIG. 4 allow the discharge chamber to be constructed with a single bond between each plug member 120, 124 and the body member 122. The flange 130 is seated within the body during assembly, and forms a thickened wall portion 134 (FIG. 3) of the body in the assembled arc tube. The inner edge of the flange 130 has an upward taper 136, which is seated with the highest, outer, edge in contact with the inside of the body portion, so as to discourage any of the fill from settling around the junction between the wall 134 and the body portion.

It will be appreciated that the arc tube can be constructed from fewer or greater number of components, such as one or five components. In a five component structure, the plug members are replaced by separate leg and end wall members which are bonded to each other during assembly.

The body member 122 and the plug members 120, 124 can be constructed by die pressing a mixture of a ceramic powder and a binder into a solid cylinder. Typically, the mixture comprises 95-98% by weight ceramic powder and 2-5% by weight organic binder. The ceramic powder may comprise alumina (Al₂O₃) having a purity of at least 99.98% and a surface area of about 2-10 m²/g. The alumina powder may be doped with magnesia to inhibit grain growth, for example in an amount equal to 0.03%-0.2%, in one embodiment, 0.05%, by weight of the alumina. Other ceramic materials which may be used include non reactive refractory oxides and oxynitrides such as yttrium oxide, lutetium oxide, and hafnium oxide and their solid solutions and compounds with alumina such as yttrium-aluminum-garnet and aluminum oxynitride. Binders which may be used individually or in combination include organic polymers such as polyols, polyvinyl alcohol, vinyl acetates, acrylates, cellulosics and polyesters.

An exemplary composition which can be used for die pressing a solid cylinder comprises 97% by weight alumina powder having a surface area of 7 m²/g, available from Baikowski International, Charlotte, N.C. as product number CR7. The alumina powder was doped with magnesia in the amount of 0.1% of the weight of the alumina. An exemplary binder includes 2.5% by weight polyvinyl alcohol and ½% by weight Carbowax 600, available from Interstate Chemical.

Subsequent to die pressing, the binder is removed from the green part, typically by thermal pyrolysis, to form a bisque-fired part. The thermal pyrolysis may be conducted, for example, by heating the green part in air from room temperature to a maximum temperature of about 900-1100° C. over 4-8 hours, then holding the maximum temperature for 1-5 hours, and then cooling the part. After thermal pyrolysis, the porosity of the bisque-fired part is typically about 40-50%.

The bisque-fired part is then machined. For example, a small bore may be drilled along the axis of the solid cylinder which provides the bore 66, 68 of the plug portion 120, 124 in FIG. 4. A larger diameter bore may be drilled along a portion of the axis of the plug portion to define the flange 130. Finally, the outer portion of the originally solid cylinder may be machined away along part of the axis, for example with a lathe, to form the outer surface of the plug portion 120, 124.

The machined parts 120, 122, 124 are typically assembled prior to sintering to allow the sintering step to bond the parts together. According to an exemplary method of bonding, the densities of the bisque-fired parts used to form the body member 122 and the plug members 120, 124 are selected to achieve different degrees of shrinkage during the sintering step. The different densities of the bisque-fired parts may be achieved by using ceramic powders having different surface areas. For example, the surface area of the ceramic powder used to form the body member 122 may be 6-10 m²/g, while the surface area of the ceramic powder used to form the plug members 120, 124 may be 2-3 m²/g. The finer powder in the body member 122 causes the bisque-fired body member 122 to have a smaller density than the bisque-fired plug members 120, 124 made from the coarser powder. The bisque-fired density of the body member 122 is typically 42-44% of the theoretical density of alumina (3.986 g/cm³), and the bisque-fired density of the plug members 120, 124 is typically 50-60% of the theoretical density of alumina. Because the bisque-fired body member 122 is less dense than the bisque-fired plug members 120, 124 the body member 122 shrinks to a greater degree (e.g., 3-10%) during sintering than the plug member 120, 124 to form a seal around the flange 130. By assembling the three components 120, 122, 124 prior to sintering, the sintering step bonds the two components together to form a discharge chamber.

The sintering step may be carried out by heating the bisque-fired parts in hydrogen having a dew point of about 10-15° C. Typically, the temperature is increased from room temperature to about 1850-1880° C. in stages, then held at 1850-1880° C. for about 3-5 hours. Finally, the temperature is decreased to room temperature in a cool down period. The inclusion of magnesia in the ceramic powder typically inhibits the grain size from growing larger than 75 microns. The resulting ceramic material comprises a densely sintered polycrystalline alumina.

According to another method of bonding, a glass frit, e.g., comprising a refractory glass, can be placed between the body member 122 and the plug member 120, 124, which bonds the two components together upon heating. According to this method, the parts can be sintered independently prior to assembly.

The body member 122 and plug members 120, 124 typically each have a porosity of less than or equal to about 0.1%, preferably less than 0.01%, after sintering. Porosity is conventionally defined as the proportion of the total volume of an article which is occupied by voids. At a porosity of 0.1% or less, the alumina typically has a suitable optical transmittance or translucency. The transmittance or translucency can be defined as “total transmittance”, which is the transmitted luminous flux of a miniature incandescent lamp inside the discharge chamber divided by the transmitted luminous flux from the bare miniature incandescent lamp. At a porosity of 0.1% or less, the total transmittance is typically 95% or greater.

According to another exemplary method of construction, the component parts of the discharge chamber are formed by injection molding a mixture comprising about 45-60% by volume ceramic material and about 55-40% by volume binder. The ceramic material can comprise an alumina powder having a surface area of about 1.5 to about 10 m²/g, typically between 3-5 m²/g. According to one embodiment, the alumina powder has a purity of at least 99.98%. The alumina powder may be doped with magnesia to inhibit grain growth, for example in an amount equal to 0.03%-0.2%, e.g., 0.05%, by weight of the alumina. The binder may comprise a wax mixture or a polymer mixture.

In the process of injection molding, the mixture of ceramic material and binder is heated to form a high viscosity mixture. The mixture is then injected into a suitably shaped mold and subsequently cooled to form a molded part.

Subsequent to injection molding, the binder is removed from the molded part, typically by thermal treatment, to form a debindered part. The thermal treatment may be conducted by heating the molded part in air or a controlled environment, e.g., vacuum, nitrogen, rare gas, to a maximum temperature, and then holding the maximum temperature. For example, the temperature may be slowly increased by about 2-3° C. per hour from room temperature to a temperature of 160° C. Next, the temperature is increased by about 100° C. per hour to a maximum temperature of 900-1100° C. Finally, the temperature is held at 900-1100° C. for about 1-5 hours. The part is subsequently cooled. After the thermal treatment step, the porosity is about 40-50%.

The bisque-fired parts are typically assembled prior to sintering to allow the sintering step to bond the parts together, in a similar manner to that discussed above.

In tests formed on the lamps it has been found that lamps can be formed which are capable of operating at a power of at least 200 W, and which can be 300-400 W, or higher, and which are optimized when the L/D follows the relationship 1.50<L/D<2.00. In one embodiment, the wall thickness is greater than 1.1 mm. In another embodiment, the wall loading is less than 0.20 W/mm². Under such conditions, a lamp operated with a pulse arc ballast which has a nominal operating voltage of about 135V can have an Ra of above 90, and efficiency of at least 90, and in some cases, as high as 95%, and a power factor (PF) of at least 0.87, and in one embodiment, 0.88 or higher. In one embodiment, PF is at least 0.90. To achieve these results, the lamp may be operated at somewhat higher than the nominal operating voltage of the ballast, e.g., up to about 10V, in one embodiment, up to about 5V over the nominal voltage (135-140V in the case of a ballast with a nominal operating voltage of 135V). One exemplary lamp has a wattage of 250 W. For a HPS ballast with a nominal operating voltage of 100V, an optimal operating voltage may also be higher, e.g., up to about

Without intending to limit the scope of the present invention, the following examples demonstrate the formation of lamps using ceramic vessels with improved performance.

### EXAMPLES

### Example 1

Arctubes are formed according to the shape shown in FIG. 2 from three component parts, as illustrated in FIG. 4. A fill comprising 20.6% NaI, 2.1%Tl, 12.8% DyI3, 6.5% HoI3, 6.5% TmI3, 0.8% CeI3, 48% CaI2, and 2.7% CsI is used. The metal halide arctubes are back filled with a rare gas, comprising Ar and a small addition of Kr85. The cold fill pressure is 130 Torr. The arctubes are assembled into lamps having an outer vacuum jacket and a quartz shroud to contain possible arctube rupture, and which are run on North American “Pulse Arc” ballasts. The arctube leg geometry, leadwire design, seal parameters, and outer jacket are the same for all lamps tested, except that the 320 W has different electrodes.

Lamps formed as described above are run in a vertical orientation (i.e., as illustrated in FIG. 3) with the lamp cap positioned uppermost. TABLE 1 illustrates properties of the lamps and properties during operation. Each data point represents an average of a population of lamps built to the same arctube design.

Of the runs listed, the following were found to yield particularly effective results: Run nos. 9, 12.

For lamps operation in the range of about 300-400 W, the following relationships have been found to apply:
PF=0.9875+0.0431*L/D+0.0044*WL−0.00052*HW−0.0011*Vop
Eff=107.57−8.464*L/D−83.7*WL−0.169*HW+0.167*Vop
Ra=75.365−0.4401*L/D+64.7*WL+0.1029* HW+0.0058*Vop

Where PF is the arctube power factor, defined as operating power divided by current times voltage. An optimal PF for operation on a Pulse Arc ballast is nominally 0.91, but it has been found in practice that PF can be slightly lower, e.g., 0.87, or higher, in one embodiment, 0.88 or higher. Eff is lamp efficacy in lumens/watt, which for optimal performance is maximized, i.e., approaching 100 lumens/watt, or higher. Ra is color rendering index, which for optimal performance, is also maximized, i.e., as close to 100 as possible. It will be appreciated that optimization of all three properties, PF, Ra, and Eff. is not generally possible, since to optimize one tends to result in one or more of the other two properties being less than optimal. Consequently, an overall optimization of the lamp involves a balancing of the three factors.

For example, the maximum Eff was found as a function of L/D subject to the constraints that Ra>91 and PF=0.91*135/Vop (See FIG. 6). The latter constraint ensures that reductions in power factor below the nominal (for the particular ballast used) are compensated by increases in voltage above the nominal so as to keep power at or about the nominal value. The maximum Eff was always found at the limit Ra=91, one example of the inevitable tradeoffs made in arctube design. Calculated data are shown in FIG. 5, with the optimized values for this particular application enclosed inside a rectangle. The maximum Eff is found at L/D=1.65. Below that value the solutions are rejected because they require that Vop>140V, a safe practical upper limit for ballast compatibility in the particular instance. If the ballast can operate at higher voltages, this can be increased. The optimum for the application described in this example is found at HW=45 mg and WL=0.17 W/mm². Practical designs may deviate somewhat from this theoretical optimum because arctube diameters are often available only in discrete settings.

### Example 2

Arctubes are formed as for Example 1. according to the shape shown in FIG. 2 from three component parts, as illustrated in FIG. 4. A fill comprising by weight 35.3% NaI, 4.9% TlI, 6.3% DyI3, 3.2% HoI3, 3.2% TmI3, 41.6% CaI2 and 5.5% CsI is used. The metal halide arctubes are back filled with a rare gas, comprising Ar and a small addition of Kr85. The cold fill pressure is 130 Torr. The arctubes are assembled into lamps having an outer vacuum jacket and are run on a HPS ballast. The arctube leg geometry, leadwire design, seal parameters, and outer jacket are the same for all lamps tested. Small changes to the design of the electrode accommodate the different arc currents at the different power loads.

Lamps formed as described above are run either in a vertical orientation VBU (i.e., as illustrated in FIG. 3) with the lamp cap positioned uppermost, or in a horizontal orientation HOR (as illustrated in FIG. 2). TABLE 2 illustrates properties of the lamps and properties during operation. Each data point represents an average of a population of lamps built to the same arctube design.

The halide composition is suited to achieving Ra>80, Eff>90 lm/W and CCT˜3000K on HPS ballasts. Runs 41, 42, 51, and 52 were found to be particularly effective for the conditions used in this example.

With sufficient data, a regression analysis for the HPS ballast design data can be generated, like that shown above for the PA ballast data.

The invention has been described with reference to the preferred embodiments. Obviously, modifications and alterations will occur to others upon reading and understanding the preceding detailed description. It is intended that the invention be construed as including all such modifications and alterations.

TABLE 1

| | Power | Vop | HW | Int. Dia. | Int. Len. | Int. | Ext. Area | Ext. WL | Ttw | Ttb | Efficiency | CRI | CCT |
|---|---|---|---|---|---|---|---|---|---|---|---|---|---|
| Run | (W) | (V) | (mg) | (mm) | (mm) | L/D | (mm²) | (W/mm²) | (mm) | (mm) | (lm/W) | (Ra) | (K) |
| 1 | 400 | 148 | 45 | 15.8 | 26.0 | 1.65 | 2283 | 0.175 | 1.55 | 3.1 | 99 | 92 | 3812 |
| 2 | 400 | 166 | 45 | 15.8 | 26.0 | 1.65 | 2283 | 0.175 | 1.55 | 3.1 | 97 | 92 | 3647 |
| 3 | 400 | 154 | 55 | 15.8 | 26.0 | 1.65 | 2283 | 0.175 | 1.55 | 3.1 | 97 | 93 | 3693 |
| 4 | 400 | 169 | 55 | 15.8 | 26.0 | 1.65 | 2283 | 0.175 | 1.55 | 3.1 | 98 | 93 | 3623 |
| 5 | 350 | 141 | 45 | 15.8 | 26.0 | 1.65 | 2283 | 0.153 | 1.55 | 3.1 | 98 | 90 | 3811 |
| 6 | 350 | 157 | 45 | 15.8 | 26.0 | 1.65 | 2283 | 0.153 | 1.55 | 3.1 | 97 | 90 | 3637 |
| 7 | 350 | 145 | 55 | 15.8 | 26.0 | 1.65 | 2283 | 0.153 | 1.55 | 3.1 | 97 | 91 | 3678 |
| 8 | 350 | 159 | 55 | 15.8 | 26.0 | 1.65 | 2283 | 0.153 | 1.55 | 3.1 | 98 | 91 | 3560 |
| 9 | 350 | 135 | 45 | 15.8 | 26.0 | 1.65 | 2283 | 0.153 | 1.55 | 3.1 | | | |
| 10 | 400 | 152 | 45 | 15.8 | 30.8 | 1.95 | 2568 | 0.156 | 1.55 | 3.1 | 100 | 91 | 4053 |
| 11 | 350 | 145 | 45 | 15.8 | 30.8 | 1.95 | 2568 | 0.136 | 1.55 | 3.1 | 97 | 88 | 4180 |
| 12 | 400 | 135 | 45 | 15.8 | 30.8 | 1.95 | 2568 | 0.156 | 1.55 | 3.1 | | | |
| 13 | 320 | 138 | 44 | 13.8 | 22.7 | 1.64 | 1747 | 0.183 | 1.30 | 3.1 | 93 | 92 | 3840 |
| 14 | 320 | 145 | 44 | 13.8 | 22.7 | 1.64 | 1747 | 0.183 | 1.30 | 3.1 | 94 | 92 | 3749 |
| 15 | 321 | 148 | 44 | 13.8 | 30.7 | 2.22 | 2159 | 0.149 | 1.30 | 3.1 | 93 | 90 | 4496 |
| 16 | 320 | 155 | 44 | 13.8 | 30.7 | 2.22 | 2159 | 0.148 | 1.30 | 3.1 | 95 | 89 | 4384 |
| 17 | 320 | 144 | 60 | 13.8 | 22.7 | 1.64 | 1747 | 0.183 | 1.30 | 3.1 | 91 | 93 | 3736 |
| 18 | 320 | 152 | 60 | 13.8 | 22.7 | 1.64 | 1747 | 0.183 | 1.30 | 3.1 | 92 | 93 | 3632 |
| 19 | 321 | 153 | 60 | 13.8 | 30.7 | 2.22 | 2159 | 0.149 | 1.30 | 3.1 | 92 | 92 | 4227 |
| 20 | 321 | 162 | 60 | 13.8 | 30.7 | 2.22 | 2159 | 0.149 | 1.30 | 3.1 | 94 | 91 | 4026 |
| 21 | 319 | 150 | 52 | 13.8 | 26.7 | 1.93 | 1953 | 0.164 | 1.30 | 3.1 | 95 | 92 | 3919 |
| 22 | 300 | 135 | 44 | 13.8 | 22.7 | 1.64 | 1747 | 0.172 | 1.30 | 3.1 | 93 | 91 | 3871 |
| 23 | 300 | 142 | 44 | 13.8 | 22.7 | 1.64 | 1747 | 0.172 | 1.30 | 3.1 | 95 | 91 | 3747 |
| 24 | 300 | 145 | 44 | 13.8 | 30.7 | 2.22 | 2159 | 0.139 | 1.30 | 3.1 | 92 | 89 | 4514 |
| 24 | 300 | 152 | 44 | 13.8 | 30.7 | 2.22 | 2159 | 0.139 | 1.30 | 3.1 | 93 | 88 | 4414 |
| 26 | 300 | 141 | 60 | 13.8 | 22.7 | 1.64 | 1747 | 0.172 | 1.30 | 3.1 | 92 | 93 | 3723 |
| 27 | 300 | 148 | 60 | 13.8 | 22.7 | 1.64 | 1747 | 0.172 | 1.30 | 3.1 | 93 | 92 | 3601 |
| 28 | 300 | 149 | 60 | 13.8 | 30.7 | 2.22 | 2159 | 0.139 | 1.30 | 3.1 | 91 | 91 | 4303 |
| 29 | 301 | 158 | 60 | 13.8 | 30.7 | 2.22 | 2159 | 0.139 | 1.30 | 3.1 | 93 | 90 | 4090 |
| 30 | 300 | 146 | 52 | 13.8 | 26.7 | 1.93 | 1953 | 0.154 | 1.30 | 3.1 | 94 | 91 | 3934 |
| 31 | 320 | 142 | 44 | 13.8 | 22.7 | 1.64 | 1747 | 0.183 | 1.30 | 3.1 | 96 | 92 | 3748 |
| 32 | 300 | 139 | 44 | 13.8 | 22.7 | 1.64 | 1747 | 0.172 | 1.30 | 3.1 | 96 | 91 | 3748 |

TABLE 2

| | | | | | | Int. | | Ext. | | | | | | |
|---|---|---|---|---|---|---|---|---|---|---|---|---|---|---|
| | Power | Vop | Orien- | HW | Int. Dia. | Length | Int. | Area | Ext. WL | Ttw | Ttb | Efficiency | CRI | CCT |
| Run | (W) | (V) | tation | (mg) | (mm) | (mm) | L/D | (mm²) | (W/mm²) | (mm) | (mm) | (lm/W) | (Ra) | (K) |
| 33 | 274 | 129 | VBU | 60 | 22.5 | 22.5 | 1.89 | 1492 | 0.183 | 1.30 | 3.1 | 100 | 84 | 3175 |
| 34 | 272 | 124 | VBU | 60 | 22.5 | 22.5 | 1.89 | 1492 | 0.182 | 1.30 | 3.1 | 100 | 84 | 3204 |
| 35 | 276 | 128 | VBU | 50 | 22.5 | 22.5 | 1.89 | 1492 | 0.185 | 1.30 | 3.1 | 102 | 82 | 3170 |
| 36 | 273 | 123 | VBU | 50 | 22.5 | 22.5 | 1.89 | 1492 | 0.183 | 1.30 | 3.1 | 101 | 83 | 3240 |
| 37 | 264 | 139 | HOR | 60 | 22.5 | 22.5 | 1.89 | 1492 | 0.177 | 1.30 | 3.1 | 96 | 87 | 2964 |
| 38 | 262 | 135 | HOR | 60 | 22.5 | 22.5 | 1.89 | 1492 | 0.176 | 1.30 | 3.1 | 95 | 87 | 2923 |
| 39 | 266 | 137 | HOR | 50 | 22.5 | 22.5 | 1.89 | 1492 | 0.178 | 1.30 | 3.1 | 96 | 86 | 2956 |
| 40 | 267 | 133 | HOR | 50 | 22.5 | 22.5 | 1.89 | 1492 | 0.179 | 1.30 | 3.1 | 96 | 87 | 2933 |
| 41 | 269 | 114 | VBU | 55 | 22.5 | 22.5 | 1.89 | 1492 | 0.181 | 1.30 | 3.1 | 99 | 83 | 3419 |
| 42 | 266 | 123 | HOR | 55 | 22.5 | 22.5 | 1.89 | 1492 | 0.179 | 1.30 | 3.1 | 94 | 87 | 2925 |
| 43 | 426 | 110 | VBU | 40 | 26.0 | 26.0 | 1.65 | 2283 | 0.187 | 1.55 | 3.1 | 102 | 80 | 3364 |
| 44 | 437 | 120 | VBU | 40 | 26.0 | 26.0 | 1.65 | 2283 | 0.192 | 1.55 | 3.1 | 98 | 82 | 3185 |
| 45 | 425 | 115 | VBU | 60 | 26.0 | 26.0 | 1.65 | 2283 | 0.186 | 1.55 | 3.1 | 104 | 85 | 3140 |
| 46 | 431 | 123 | VBU | 60 | 26.0 | 26.0 | 1.65 | 2283 | 0.189 | 1.55 | 3.1 | 104 | 85 | 3048 |
| 47 | 425 | 120 | HOR | 40 | 26.0 | 26.0 | 1.65 | 2283 | 0.186 | 1.55 | 3.1 | 99 | 86 | 2970 |
| 48 | 429 | 131 | HOR | 40 | 26.0 | 26.0 | 1.65 | 2283 | 0.188 | 1.55 | 3.1 | 95 | 87 | 2917 |
| 49 | 424 | 125 | HOR | 60 | 26.0 | 26.0 | 1.65 | 2283 | 0.186 | 1.55 | 3.1 | 97 | 87 | 2950 |
| 50 | 423 | 134 | HOR | 60 | 26.0 | 26.0 | 1.65 | 2283 | 0.185 | 1.55 | 3.1 | 98 | 88 | 2906 |
| 51 | 424 | 115 | VBU | 60 | 30.8 | 30.8 | 1.95 | 2568 | 0.165 | 1.55 | 3.1 | 102 | 82 | 3464 |
| 52 | 423 | 123 | HOR | 60 | 30.8 | 30.8 | 1.95 | 2568 | 0.165 | 1.55 | 3.1 | 100 | 84 | 3063 |

HOR = Horizontal
VBU = Vertical, base up.

1. A lighting assembly comprising:
a ballast and a lamp electrically connected therewith, the ballast selected such that the lamp operates at a power of greater than 200 W, the lamp including a discharge vessel containing a fill of an ionizable material, the discharge vessel including:
a body portion which defines an interior space, the body portion having an internal length, parallel to a central axis of the discharge vessel and an internal diameter, perpendicular to the internal length, wherein a ratio of the internal length to the internal diameter is in the range of 1.5 to 2.0, and
at least one electrode positioned within the discharge vessel so as to energize the fill when an electric current is applied thereto.

2. The lighting assembly of claim 1, wherein the body is substantially cylindrical.

3. The lighting assembly of claim 1, wherein the ratio of the internal length to the internal diameter is in the range of 1.6 to 1.8.

4. The lighting assembly of claim 1, wherein the body portion of the discharge vessel has a wall loading of less than 0.20 W/mm².

5. The lighting assembly of claim 1, wherein the body portion has a wall thickness in the range of from 1.1 mm to 1.5 mm.

6. The lighting assembly of claim 1, wherein the discharge vessel is formed from ceramic.

7. The lighting assembly of claim 1, wherein the fill comprises Hg and iodides of one or more of Na, Tl, Dy, Ho, Tm, Ce, Cs, and Ca and at least one inert gas selected from Ar and Xe.

8. The lighting assembly of claim 1, wherein the body portion includes a substantially cylindrical wall and two spaced end walls connected at either end of the cylindrical wall, the end walls lying generally perpendicular to the central axis.

9. The lighting assembly of claim 8, wherein the discharge vessel further includes at least one leg portion, extending from at least one of the end walls which supports the at least one electrode at least partially therein.

10. The lighting assembly of claim 9, wherein the leg portion and the end wall define a fillet at their intersection on an exterior surface of the discharge vessel.

11. The lighting assembly of claim 1, wherein at least one of the following conditions is satisfied:
a) the lamp has a color rendition index of at least 90
b) the lamp has an efficiency of at least 90 lumens/watt;
c) the ballast is a pulse arc ballast with a nominal lamp power factor of 0.91 and the assembly has a lamp power factor of at least 0.87.

12. The lighting assembly of claim 1, wherein the ballast includes one of a pulse arc ballast, a pulse start ballast, and a high pressure sodium ballast.

13. The lighting assembly of claim 1, wherein the lamp operates at a power of at least 250 W.

14. The lighting assembly of claim 1, wherein the lamp operates at a power of 300-400 W.

15. The lighting assembly of claim 1, wherein the at least one electrode includes two axially spaced electrodes spaced about 16-25mm apart.

16. The lighting assembly of claim 1, further including:
an outer bulb which surrounds the discharge vessel.

17. A ceramic metal halide lamp capable of operating at a power of at least 200 W comprising:
a body portion formed of a ceramic material which defines an interior space, the body portion having an internal length, parallel to a central axis of the discharge vessel and an internal diameter, perpendicular to the internal length, wherein a ratio of the internal length to the internal diameter is in the range of 1.5 to 2.0;
spaced electrodes which extend into the body portion; and
an ionizable fill disposed in the body portion.

18. A method of forming a lighting assembly capable of operating at a power of at least 200 W, the method comprising:
providing a substantially cylindrical discharge vessel comprising a body portion and first and second leg portions extending from the body portion, the body portion having an aspect ratio of internal length to internal diameter of from 1.5 to 2.0 and a wall thickness of at least 1 mm;
disposing an ionizable fill in the body portion;
positioning electrodes within the discharge vessel which energize the fill when an electric current is applied thereto.

19. The method of claim 18, further including:
connecting a ballast with the electrodes; and
supplying an electric current to at least one of the electrodes such that light is emitted from the discharge vessel when the lighting assembly operates at a power of at least 200 W.

20. The method of claim 19, wherein during operation, the body has a wall loading of less than 0.20 W/mm².
